(19) United States
(12) Patent Application Publication
(10) Pub. No.: US 2021/0097269 A1
(43) Pub. Date: Apr. 1, 2021

(54) SMART DIRECTING METHOD

(71) Applicant: AVerMedia Technologies, Inc., New Taipei City (TW)

(72) Inventors: Yen-Ting Chen, New Taipei City (TW); Po-Yang Yao, New Taipei City (TW); Nian-Ying Tsai, New Taipei City (TW); Chao-Tung Hu, New Taipei City (TW)

(21) Appl. No.: 17/026,362

(22) Filed: Sep. 21, 2020

(30) Foreign Application Priority Data
Sep. 26, 2019 (TW) 108134809

(51) Int. Cl. G06K 9/00; H04N 21/2187; H04N 21/442

(52) U.S. Cl. CPC G06K 9/00369; G06K 9/00288; G06K 9/00744; H04N 21/44218; H04N 21/2187

(57) ABSTRACT

A smart directing method includes the steps of capturing a first video of a video capture device, detecting at least one person from the first video and determine whether the person is out of the first video or not, and triggering a change direct mode so as to show a change direct scene on at least one remote end apparatus when the detected person is out of the first video.

### CROSS REFERENCE TO RELATED APPLICATIONS

This Non-provisional application claims priority under 35 U.S.C. § 119(a) on Patent Application No. 108134809 filed in Republic of China on Sep. 26, 2019, the entire contents of which are hereby incorporated by reference.

### BACKGROUND

### 1. Technical Field

The present invention generally relates to a directing method, and more particularly, to a smart directing method.

### 2. Description of Related Art

At present, when directing between the live streamer and the audience, the live streamer may temporarily leave the scene due to something unexpected, resulting in the live video picture staying in the scene without the live streamer or instructor, leaving the audience in a state of being idle or unaware of the situation, thus reducing the audience's online rate.

Therefore, it is obvious that there are still some deficiencies in the current directing methods concerning the above problems, which need to be improved.

### SUMMARY OF THE INVENTION

The present invention is to provide a smart directing method, including the steps of capturing a first video of a video capture device, detecting at least one person from the first video and determine whether the person is out of the first video or not, and triggering a change direct mode so as to play a change direct scene on at least one remote end apparatus when the detected person is out of the first video.

In the smart directing method of the present invention, the step detecting at least one person in the first video and determining whether the person is out of the first video further includes: to detect at least one recognition characteristics of at least one person in the first video, and to determine whether at least one recognition characteristic is in the first video.

In the smart directing method of the present invention, the recognition characteristics could be at least a face recognition, a body characteristic, a voice recognition, an identity (ID) recognition, and/or an object characteristic worn on the person.

In the smart directing method of the present invention, the change direct scene is composed of at least a text, sound, webpage embedded screen, real-time image, default image, picture, and/or screenshot.

In the smart directing method of the present invention, the change direct scene could also includes the first video.

In the smart directing method of the present invention, the smart directing method further includes the following steps: transmitting an original direct scene to the remote end apparatus, so that the remote end apparatus plays the original direct scene.

In the smart directing method of the present invention, the step triggering the change direct mode could also includes the following steps: transferring the original direct scene to the change direct scene, and transmitting the change direct scene to at least one remote end apparatus, so that at least one remote end apparatus plays the change direct scene.

In the smart directing method of the present invention, the original direct scene is composed of at least a text, a voice, a webpage embedded screen, a real-time image, a default image, a picture, and/or a screen shot.

In the smart directing method of the present invention, the original direct scene could also includes the first video.

In the smart directing method of the present invention, the video capture device could be a camera, at least one person is a live streamer.

In the smart directing method of the present invention, the step triggering the change direct mode includes the following steps: transmitting the change direct scene to the remote end apparatus through a live stream, so that the remote end apparatus directs the change direct scene to at least one audience.

In the smart directing method of the present invention, the video capture device could be a part of near-end apparatus.

Therefore, according to the present invention, the technical content of a smart directing method is provided, in which when the detected person leaves the first video, it will trigger the change direct mode, so that the audience of the remote end apparatus can see the change direct mode and maintain a high online rate.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

In order to make the above and other objectives, features, advantages and embodiments of the present invention more obvious and understandable, the description of the accompanying drawings is as follows.

FIG. 1 is a schematic flow diagram showing a smart directing method according to an embodiment of the invention.

FIG. 2 is a first state schematic diagram showing the smart directing method, where a person in the first video is leaving according to the embodiment of the embodiment.

FIG. 3 is a second state schematic diagram showing the smart directing method, where a person in the first video is leaving according to the embodiment of the embodiment.

FIG. 4 is a third state schematic diagram showing the smart directing method, where a person in the first video is leaving according to the embodiment of the embodiment.

FIG. 5 is a schematic diagram showing a structure of the smart directing method according to the embodiment of the embodiment.

FIG. 6 is a schematic diagram showing a setting interface of the smart directing method according to the embodiment of the embodiment.

FIG. 7 is a schematic diagram showing another setting interface of the smart directing method according to the embodiment of the embodiment.

### DETAILED DESCRIPTION

Reference will now be made to the drawings to describe various inventive embodiments of the present disclosure in detail, wherein like numerals refer to like elements throughout.

The terminology used herein is for the purpose of describing the particular embodiment and is not intended to limit the application. The singular forms “a”, “an”, “the”, “this” and “these” may also include the plural.

As used herein, “the first”, “the second”, etc., are not specifically meant to refer to the order, nor are they intended to limit the application, but are merely used to distinguish elements or operations that are described in the same technical terms.

As used herein, “coupled” or “connected” may mean that two or more elements or devices are directly contacted in physical with each other, or indirectly contacted in physical with each other, may also mean that two or more elements or devices operate or interact with each other, and may also refer to a direct or indirect connection by electrical (or electrical signals).

As used herein, “including”, “comprising”, “having”, and the like are all open type terms, meaning to include but not limited to.

As used herein, “and/or” includes any one or all combinations of the recited.

Regarding the directional terminology used herein, for example, up, down, left, right, front or back, etc., only refers to the direction of the additional drawing. Therefore, the directional terminology used is used to illustrate that it is not intended to limit the application.

Regarding the terms used in this specification, unless otherwise noted, usually have the usual meaning of each term used in this field, in the context of the application, and in particular content. Certain terms used to describe the present invention are discussed below or elsewhere in this specification to provide additional guidance to those skilled in the art in the description of the present invention.

As used herein, “video” may refer to an audio-visual signal that contains sound or an image signal that does not contain sound.

As used herein, “scene” may mean that the corresponding scene information can be configured at any position and/or any time in the set frame, such as at least one of text, sound, web page embedding, screen, real-time/default image, picture, and/or screenshot, etc., or a combination thereof can be formed, and there is no limitation here.

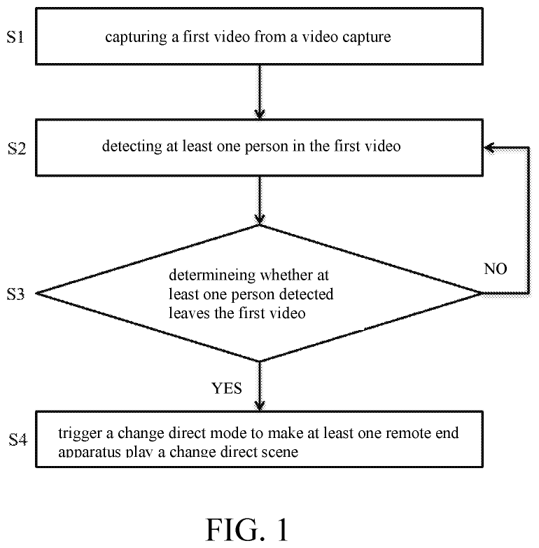

FIG. 1 discloses a smart directing method according to an embodiment of the invention, which at least includes steps S1˜S4. Step S1 is to capture a first video from a video capture device. Step S2 is to detect at least one person in the first video. Step S3 is to determine whether at least one person detected leaves the first video. In Step S3, when at least one person detected leaves the first video, Step S4 shall be performed, where Step S4 is to trigger a change direct mode to make at least one remote end apparatus play a change direct scene.

Therefore, according to one smart directing method according to the embodiment of the invention, when the detected person leaves the first video, the change direct mode will be triggered, so that the audience of the remote end apparatus can see the change direct scene and maintain a high online rate.

A video capture device may be a capture device that does not contain a photography module (such as a capture card or capture box), or a capture device that contains a photography module (such as a camera), without limitation here. In addition, the aforementioned photography module can be pointed at the aforementioned person (such as the live streamer), so that the aforementioned person exists in the first video captured by the video capture device.

In Step S2 of the embodiment, the mode to detect the person in the first video can be to detect at least one recognition characteristics of the detected person, among them, the foregoing recognition characteristics could have different states based on actual demand, for example, it may be composed of at least one characteristic or a combination of a human face recognition, a body characteristic, a voice recognition, an identity (ID) recognition, and/or characteristics of a particular object worn on the person, among which, the body characteristics can be the human body characteristics outside of face, such as the hair color, shape, skin color, posture, movement, iris and other body characteristics, without limitation here. In addition, the characteristics of a particular object worn by the person may be other characteristics of other particular objects that can be worn on the person, such as the name brand, decorations, clothing, and electronic device, etc., without limitation here.

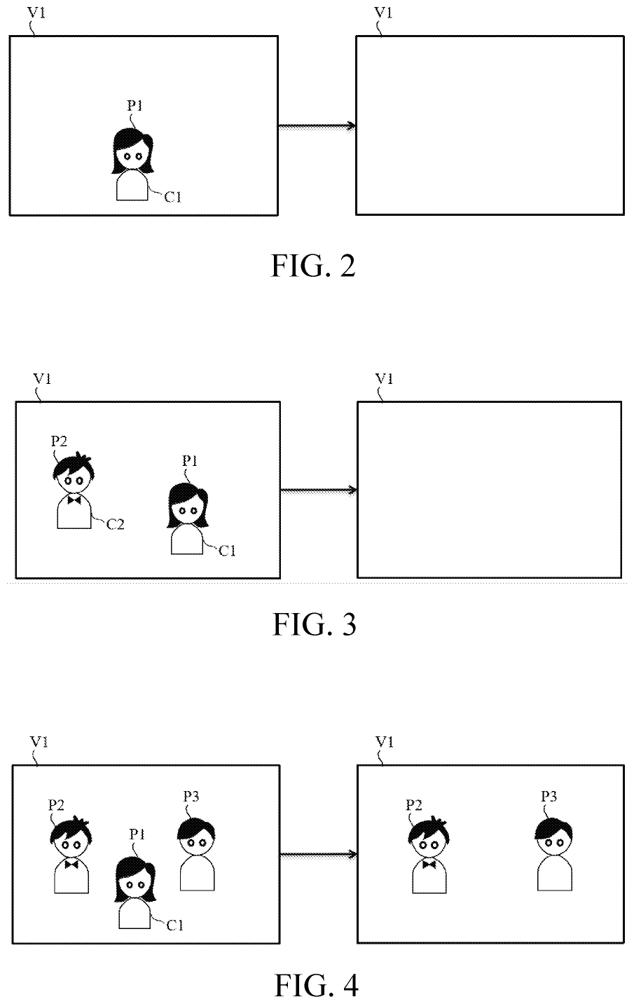

Further to the above, in Step S3 of the embodiment, the determination of whether the detected person is away from the first video can be made by determining whether the aforementioned recognition characteristic is still in the first video. Please refer to FIG. 2. For example, in the algorithm, N=1 is defined if a recognition characteristic C1 of person P1 exists the first video V1, and N=0 is defined if the recognition characteristic C1 does not exist in the first video V1. Where, Step S3 can determine whether the detected person C1 leaves the first video V1 according to the state of N=0 or N=1. Of course, the person can also be of multiple characteristics (not shown in the figure); for example, if a person has two recognition characteristics described (such as first and second recognition characteristics), when the first recognition characteristic of the person does not exist in the first video, and the second recognition characteristic also does not exist in the first video, M=0 is defined; when at least one of the first and/or second recognition characteristics is in the first video, M=1 is defined, so as to determine that the person does not leave the first video on the basis of M=1, and to determine that the person does not leave the first video on the basis of M=0, which more improves the accuracy of detection. Of course, the calculation method of the algorithm can be changed according to the actual demand and is not limited by the example.

In addition, when there are multiple persons in the first video, the algorithm can also have different methods according to the actual demand. As shown in FIG. 3, for example, when there are two people P1/P2 in the first video V1, where, when there is no recognition characteristics C1 of the first person P1 and recognition characteristics C2 of the second person P2 in the first video V1, L=0 is defined. When at least one of the recognition characteristics C1 of the first person P1 and/or the recognition characteristics C2 of the second person P2 in the first video V1, L=1 is defined. In other words, when L=0, it means that the person leaves the first video V1, and L=1 means that at least one of them does not leave the first video V1, so as to serve as the basis for subsequent judgment of the person's leaving.

Furthermore, when there are multiple persons in the first video, it can also be judged that the person leaves the first video as long as there is no recognition characteristics of a specific person in the first video. Please refer to FIG. 4. For example, when there are three persons P1/P2/P3 in the first video V1, where the recognition characteristics C1 of the first person P1 is an ID recognition characteristic. Among them, when the recognition characteristics C1 of the first person P1 does not exist in the first video V1, Q=0 is defined; when the recognition characteristics C1 of the first person P1 is in the first video V1, Q=1 is defined, and whether the second person P2 and third person P3 leave the first video V1 does not affect the judgement; in other words, when Q=0, it means the specific person P1 left the first video V1; when Q=1, it means the specific person P1 does not leave the first video V1, so as to serve as the basis for subsequent judgment of the person's leaving.

Furthermore, the time point when at least one detected person leaves the first video by Step S3 can be used to judge as entering Step S4 when the person leaves, or entering Step S4 after a time interval when the person leaves. Moreover, it also can judge to enter Step S4 when the person is about to leave the first video; for example, the recognition characteristics of the person can be the movement characteristic in the body characteristics, as well as the boundary characteristics of first video; when judging the movement characteristic will leave the boundary characteristic, namely that the person is about to leave the first video, so it shall enter Step S4.

Please refer to FIG. 1 again. In Step S3, if the person does not leave the first video, that is the “No” on the flow chart, the flow can go back to Step S2 and continue to detect.

In Step S3, when judging the person leaves the first video, Step S4 is started, in which Step S4 is to trigger a change direct mode and make at least one remote end apparatus playing a change direct scene. The change direct scene may consist of at least one of text, sound, webpage embedded screen, real-time image, default image, picture, and/or screenshot. In addition, the change direct scene can be determined by the user (such as the live streamer) to contain the first video or not according to the actual demand.

The change direct mode may refer to transferring a change direct scene, which can be preset or generated in real time, to a remote end apparatus by switching or attaching, and playing the change direct scene on the remote end apparatus, so that the audience of the remote end apparatus can see the change direct scene. For example, the change direct scene can be an advertising scene; when Step S3 judges the person leaves the first video, the audience can see the advertising scene on the remote end apparatus, the advertising scene can be attached to the original scene (PIP/POP), and also can be spliced with the original scene (PBP), or switching the original scene into the advertising scene, so that, when the detected person (such as the live streamer) leaves the first video, the audience can see change direct scene (advertising scene), to maintain a high online rate.

The smart directing method can also include a step (not shown in the figure): the step is to transmit an original direct scene to a remote end apparatus, so that the remote end apparatus can play the original direct scene. The original direct scene may consist of at least one of text, sound, webpage embedded image, real-time image, default image, picture, and/or screenshot. In addition, the original direct scene can be decided by the user (such as the live streamer) to contain the first video or not according to the actual demand.

Further to the above, the change direct mode of Step S4 may refer to converting the original direct scene into the change direct scene, and then transferring the change direct scene to at least one remote end apparatus, so that at least one remote end apparatus can play the change direct scene.

Moreover, the transmission of change direct scene or the original direct scene to a remote end apparatus can be done through the live streaming, so that the audience can see the scene remotely. For example, when the person (the live streamer) does not leave the first video, the audience can see the original direct scene on the remote end apparatus. When the person leaves the first video, the audience can see the change direct scene on the remote end apparatus.

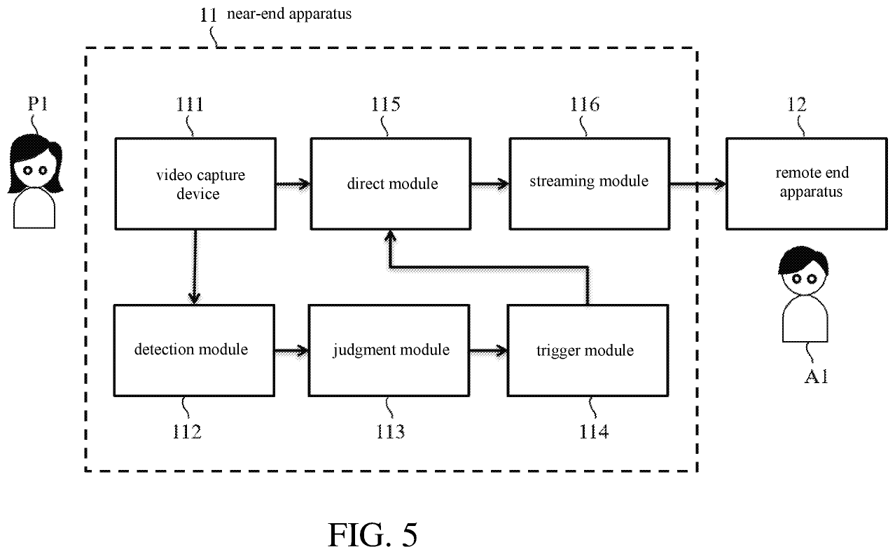

In order to explain the structure of the example of this invention more clearly, an example of the structure is given here. FIG. 5 shows a smart directing system containing, for example, a video capture device 111, a direct module 115, a streaming module 116, a detection module 112, a judgment module 113 and a trigger module 114. The above modules are part of the near-end apparatus 11, which is operated by the person P1. The person P1 can, for example, be the live streamer. The video capture device 111 may also be part of a near-end apparatus. In addition, the above-mentioned modules can be implemented in the software or hardware according to actual demand, without limitation here.

Please refer to both FIG. 1 and FIG. 5 for the video capture device 111, which can perform Step S1. The video capture device 111 may refer to a capture device that does not contain a photography module (such as a capture card or capture box), or a capture device that contains a photography module (such as a camera), without limitation here. In addition, the aforementioned photography module can be pointed at the aforementioned person P1 (such as the live streamer), so that the aforementioned person P1 exists in the first video captured by the video capture device 111.

The video capture device 111 can be connected to the detection module 112 to transmit the captured first video to the detection module 112. The detection module 112 can execute Step S2. The detection module 112 can be connected to the judgment module 113, and the judgment module 113 can implement Step S3; the trigger module 114 can be respectively connected to the judgment module 113 and direct module 115; when the result of judgment module 113 is Yes, the trigger module 114 can trigger a change direct mode in Step S4; for example, when the trigger module 114 triggers the change direct mode, it can send a control signal to a direct module to make a change direct mode.

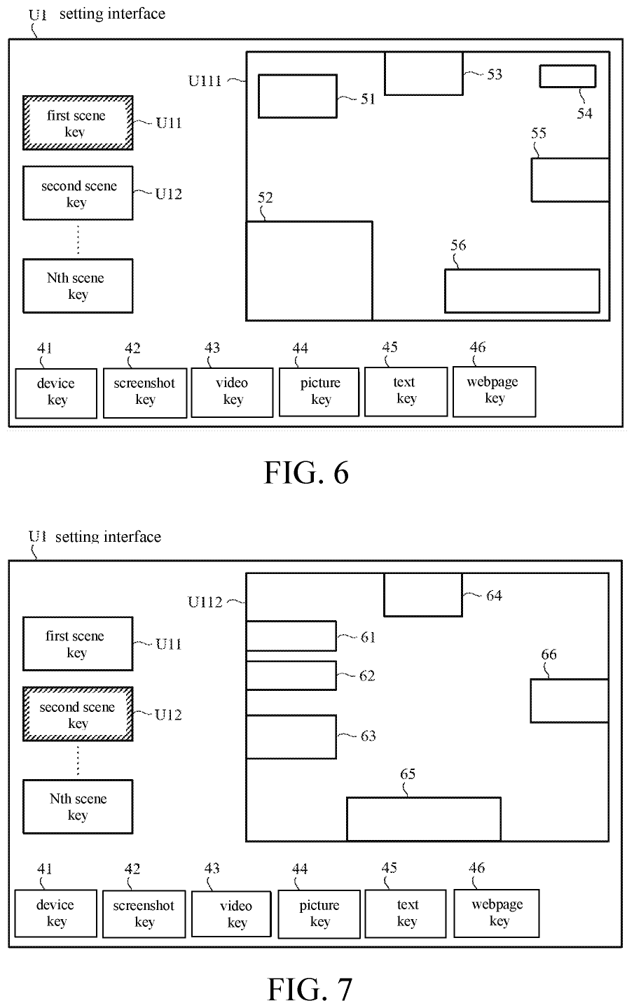

The direct module 115 can be connected with video capture device 111 and streaming module 116, respectively. For example, referring to FIGS. 5-6, the direct module 115 can contain the direct scene setting interface U1, in which the setting interface U1 can be set by the person P1; the setting interface U1 can include several scene keys according to actual demand, such as the first scene key U11 and the second scene key U12 shown in FIG. 6. Users can click the scene key U11 or scene key U12 to switch the corresponding setting. For example, clicking scene key U11 in FIG. 6 will present the preview U111 of a direct scene corresponding to scene key U11. The preview U111 of a direct scene can arrange the text, webpage embedded screen, live/default image, picture, and/or screenshot in different areas (or times) according to user requirements. For example, the setting interface U1 can include a device key 41, a screenshot key 42, a video key 43, a picture key 44, a text key 45, and a webpage key 46. These keys will generate a corresponding device scene layout 51, a screenshot scene layout 52, a video scene layout 53, a picture scene layout 54, a text scene layout 55 and a webpage scene layout 56 in the preview U111 of the direct scene. Among them, the setting interface U1 can choose these keys 41-46 to set the area position (or time) of the layout 51-56 in the preview U111, among which, each size of the layout 51-56 can be set by users, and each layout 51-56 can be overlapped or separated; the preview U111 can have multiple layout 51-56, and the whole area of preview U111 can also be the layout 51, without limitation here. The preview U111 can present at least one or several layouts 51-56. Among them, clicking the device key 41 can refer to opening the video of the corresponding device as the device scene layout 51, and the aforesaid device can refer to the video capture device 111. That is to say, when clicking the device key 41, it can set the first video captured by the video capture device 111 displayed in the device scene layout 51 of the preview U111. The function of screenshot key 42 can refer to the picture capturing the screen presented in the screenshot scene layout 52. The function of video key 43 can render the default or live video presented in the video scene layout 53. The function of picture key 44 can render the default or live picture presented in the picture scene layout 54. The function of text key 45 can render the default or live text presented in text scene layout 55. The function of webpage key 46 can allow to embed the webpage link to present in webpage scene layout 56, such as YouTube link or advertising link.

In the same way, as shown in FIG. 7, clicking the scene key U12 in FIG. 7, a direct scene preview U112 of corresponding scene key U12 will be presented, and as described above, the keys 41-46 of setting interface U1 will generate a corresponding device scene layout 61, a screenshot scene layout 62, a video scene layout 63, a picture scene layout 64, a text scene layout 65 and a webpage scene layout 66 in the preview U112 of the direct scene. The setting instructions of layout 61-66 are as that of the above layout 51-56, which is not repeated again here.

Continuing the above, the direct module 115 can set the scene according to the preview U111, and live stream to remote end apparatus 12 through the streaming module, and display the corresponding scene on the remote end apparatus 12, so that the audience A1 can see the scene presented in preview U111.

Specifically, the trigger module 114 triggers the change direct mode, which means to control the direct module 115 to make the first scene switch to the second scene. Please also refer to FIGS. 6-7. For example, the first scene key in FIG. 6 can refer to the setting key of the original direct scene, and the preview U111 is a preview of the original direct scene, while the second scene key in FIG. 7 can refer to the setting key of the change direct scene, and the preview U112 is a preview of the change direct scene. The live streamer can, for example, click the device key 41 from the preview U111 of the original direct scene to select the video capture device 111. Therefore, the device scene layout 51 will present the first video with person P1 (the live streamer). For example, the live streamer can connect the preview U112 of the change direct scene to the external advertisement by clicking the webpage key 41, so the layout of the webpage scene 66 is for the external advertisement. At this point, if the person P1 (the live streamer) does not leave the first video, the direct module will continue to transmit the first scene through streaming module (such as preview U111 in FIG. 6) to the remote end apparatus 12; at this point, the audience A1 will continue to see the first video presented in the device scene layout 51, that is the audience A1 will see a live performance video of the live streamer. On the other hand, if the person P1 (live streamer) temporarily leaves for some reasons, the detection module 112, judgment module 113 and trigger module 114 shall detect and judge the person leaves the first video, and it will trigger the change direct mode to control the direct module 115 to switch the first scene (original direct scene) to the second scene (change direct scene), and the direct module shall transfer the second scene through the streaming module (such as preview U112 in FIG. 7) to the remote end apparatus 12. At this point, the audience A1 will see the external advertisement presented in webpage scene layout 66, that is, the audience A1 will see the external advertisement. Therefore, when the person P1 (the live streamer) temporarily leaves, the audience A1 will still have other media information to watch.

In summary, it is one smart directing method of the examples of the invention, in which, when the detected person leaves the first video, it will trigger the change direct mode, so that the audience at the remote end apparatus can see the change direct scene and maintain a high online rate.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. A smart directing method, comprising:
capturing a first video from a video capture device;
detecting at least one person from the first video and determining whether the person is out of the first video; and
triggering a change direct mode so as to play a change direct scene on at least one remote end apparatus when the detected person is out of the first video.

2. The smart directing method of claim 1, wherein the step detecting at least one person in the first video and determining whether the person is out of the first video further comprising:
detecting at least one recognition characteristics of the at least one person in the first video; and
determining whether the at least one recognition characteristic is in the first video.

3. The smart directing method of claim 2, wherein the recognition characteristic comprises at least a face recognition, a body characteristic, a voice recognition, an identity (ID) recognition, and/or an object characteristic worn on the person.

4. The smart directing method of claim 1, wherein the change direct scene comprises at least a text, a sound, a webpage embedded screen, a real-time image, a default image, a picture, and/or a screenshot.

5. The smart directing method of claim 1, wherein the change direct scene comprises the first video.

6. The smart directing method of claim 1, further comprising:
transmitting an original direct scene to the remote end apparatus, so that the remote end apparatus plays the original direct scene.

7. The smart directing method of claim 6, wherein the step triggering the change direct mode comprising:
transferring the original direct scene to the change direct scene; and
transmitting the change direct scene to the at least one remote end apparatus, so that the at least one remote end apparatus plays the change direct scene.

8. The smart directing method of claim 6, wherein the original direct scene comprises at least a text, a voice, a webpage embedded screen, a real-time image, a default image, a picture, and/or a screen shot.

9. The smart directing method of claim 6, wherein the original direct scene comprises the first video.

10. The smart directing method of claim 1, wherein the video capture device is a camera, and the at least one person is a live streamer.

11. The smart directing method of claim 10, wherein the step triggering the change direct mode comprising:
transmitting the change direct scene to the remote end apparatus through a live stream, so that the remote end apparatus plays the change direct scene to at least one audience.

12. The smart directing method of claim 1, wherein the video capture device is a part of near-end apparatus.
